(19) United States
(12) Patent Application Publication
(10) Pub. No.: US 2021/0276884 A1
(43) Pub. Date: Sep. 9, 2021

(54) Liquid Treatment Device, Method of Manufacturing It and Liquid Treatment System

(71) Applicant: BRITA GMBH, Taunusstein (DE)

(72) Inventors: Marcus HORN, Wiesbaden (DE); Thomas NAGEL, Weinbach (DE)

(21) Appl. No.: 16/476,980

(22) PCT Filed: Nov. 14, 2017
(86) PCT No.: PCT/EP2017/001326

§ 371 Date: Jul. 10, 2019

(30) Foreign Application Priority Data
Nov. 14, 2016 (EP) 16198654.2

(51) Int. Cl. C02F 1/00; C02F 1/28; C02F 1/42; C02F 1/44; C02F 9/00

(52) U.S. Cl. CPC C02F 1/003; C02F 1/283; C02F 1/42; C02F 1/444; C02F 2303/04; C02F 2001/425; C02F 2201/004; C02F 2201/006; C02F 2307/04; C02F 9/005

(57) ABSTRACT

A liquid treatment device includes a body. The body includes a container section defining a container for holding liquid to be treated and a liquid treatment section defining a cavity and including at least one liquid treatment part. The body includes at least one liquid-impermeable wall defining at least a bottom of the container and at least one wall enclosing the cavity. These walls are inseparable, any seams in transitions between these walls being between parts of the body joined by bonding. The liquid treatment device is provided with at least one first liquid-permeable window allowing liquid to egress from the device and at least one second liquid-permeable window allowing liquid to flow from an interior of the container to the cavity. The liquid treatment device includes a barrier between the cavity and the container interior, inseparable from the body, the barrier including at least one of the second windows.

### FIELD OF THE INVENTION

The invention relates to a liquid treatment device including a body, the body including: a container section defining a container for holding liquid to be treated and a liquid treatment section defining a cavity and including at least one liquid treatment part, wherein the body includes at least one liquid-impermeable wall defining at least a bottom of the container and at least one wall enclosing the cavity, wherein these walls of the body are inseparable, any seams in transitions between these walls being between parts of the body joined by bonding, and wherein the liquid treatment device is provided with at least one first liquid-permeable window allowing liquid to egress from the device and at least one second liquid-permeable window allowing liquid to flow from an interior of the container to the cavity, wherein the liquid treatment device includes a barrier between the cavity and the container interior, the barrier including at least one of the second windows.

The invention also relates to a liquid treatment system.

The invention also relates to a method of manufacturing a liquid treatment device of the above-mentioned type.

### BACKGROUND OF THE INVENTION

WO 94/04245 A1 discloses a filter jug to contain water or other liquid, the jug comprising a first compartment to receive liquid from a supply, a second compartment to hold filtered liquid to be poured from an outlet from the second compartment, a filter chamber through which liquid must pass from the first compartment to the second, the filter chamber containing a filter medium and the filter medium being present in a flexible bag having a liquid-pervious wall. The first compartment is a removable inner housing dimensioned for reception in the upper part of the second compartment. In a first embodiment, a cylindrical extension depends below a hole in a floor of the inner housing and defines a filter chamber or sump. The floor has a depression in the region of the hole, and a disc-shaped lid is present to fit over the hole. In a second embodiment, an integrally formed filter chamber depends from the floor of the inner housing. The chamber has a generally cylindrical wall tapering towards its base and defines at its upper end an annular shoulder to receive a lid. The lid is of generally oval shape and has a central hump surrounded by perforations to allow liquid to pass through into the chamber. An air hold is also provided to aid water flow.

The flexible bag must be sufficiently flexible to distribute the filter medium in it evenly over the filter chamber. This filter chamber must also be free from contaminating objects. In the case of a disc-shaped lid, the shape of the lid dictates that the filter chamber must have a circular cross-section. An oval lid would allow the filter chamber to have an elongated cross-section, but such a lid cannot be held in place securely by mechanical fastening, e.g. using a bayonet lock or threaded parts. Thus, it is up to the user to plug the hole with the lid in such a way that it is not dislodged during use.

### SUMMARY OF THE INVENTION

It is an object of the invention to provide a liquid treatment device, system and method of the types mentioned above in the opening paragraphs that do not rely on a user to ensure that only and all the liquid to be treated passes from the container interior to the cavity in the liquid treatment section.

This object is achieved by the liquid treatment device according to the invention, which is characterised in that the barrier is inseparable from the body.

The liquid treatment device includes a section defining a container for holding liquid to be treated. This container may be a tank for a liquid treatment system including a suction pump. Such tanks are commonly in use in coffee makers for example. Alternatively, the container may be a component for a gravity-driven liquid treatment system. Examples include jug filters, but also gravity-driven water filter and dispensing systems provided with a dispensing valve and configured for placement on a worktop or shelf of a refrigerator. The liquid treatment device includes a liquid treatment section including at least one liquid treatment part and defining a cavity. This liquid treatment section may protrude relative to a wall of the section defining the container, e.g. such as to depend from the section defining the container, or to protrude into its interior. The at least one liquid treatment part may include a liquid treatment medium for treating an aqueous liquid, e.g. a beverage. It may in particular include a liquid treatment medium for treating mains drinking water. The at least one liquid treatment medium may include a medium for leaching a substance into the liquid to be treated, a sorbent, including at least one ion exchange material, or a combination thereof. The liquid treatment part may comprise a mechanical filter, e.g. a microbial filter device for removing bacteria and optionally viruses, e.g. a membrane filtration device. Some or all of liquid treatment medium included in at least one of the liquid treatment parts may be in a granular and/or fibrous form, bound or loose. Such a liquid treatment medium may be contained in a bag of liquid-pervious material, e.g. foil or textile material.

The liquid treatment device includes a body that includes walls transitioning into each other and inseparable from each other. That is to say that these walls are only separable in an irreversible manner, e.g. by cutting or tearing them apart, or melting material of which they are made or by which they are joined. A sub-set of the set of inseparable walls may be integral parts of a body made in one piece, e.g. a moulded body, so that transitions between the walls are seamless. Alternatively or additionally, some or all of the transitions may be formed by bonds or welds at edges of the walls. The set of walls making up the body includes at least one exterior, liquid-impermeable wall of the liquid treatment device that forms at least a bottom and sides of the section defining the container. Depending on the shape of the section defining the container, it may be possible to make out a bottom wall or the wall or walls forming the sides may curve inwards to form a bottom of the container. The barrier between an interior of the container and the cavity may be a section of a bottom wall or of the wall or walls forming the sides and curving inwards to form the bottom of the container. These walls bound the container interior such as to contact liquid to be treated when filled into the container. The walls forming the sides and an end of the liquid treatment section may also be exterior walls of the liquid treatment device, unless the liquid treatment section is arranged within the container interior. At least one of the walls of the liquid treatment device is provided with or forms at least one liquid-permeable window allowing liquid from the cavity to egress from the liquid treatment device. This will generally be one of the walls forming the sides and an end of the liquid treatment section, where the liquid treatment section is situated adjacent the container section.

One or more of the liquid-permeable windows may be formed by apertures in a liquid-impermeable wall. Alternatively, such a window may include a liquid-pervious component such as a porous body, screen or the like, which may be placed in or against an aperture in an otherwise liquid-impermeable wall in which the window is provided. The liquid-permeable windows may be configured essentially to prevent particulate matter, e.g. liquid treatment medium from escaping from the cavity, either into the interior of the container for liquid to be treated or to the downstream environment of the liquid treatment device. Only minimal amounts of abraded matter may possibly be carried out by the liquid, in use. Conversely, they also keep particulate matter out of the cavity, which may increase the useful life of the liquid treatment part.

The cavity is encased completely by walls. The liquid-permeable windows allow liquid to be treated to flow through the cavity, but the liquid treatment part cannot be removed in a non-destructive manner. When the liquid treatment part has reached the end of its useful lifetime, the entire liquid treatment device, including the section defining the container, is replaced. In effect, the liquid treatment device forms a cartridge for a liquid treatment system. Thus, there is no need to provide seals between a housing of a replaceable liquid treatment cartridge and a tank or hopper for liquid to be treated. There is also no need to provide seals between a well for holding liquid treatment medium in such a tank or hopper and a lid or cover of the well. Liquid to be treated cannot bypass the cavity in the liquid treatment section.

It can only flow through it in the intended manner, i.e. through the liquid-permeable windows.

The barrier is arranged to retain objects having a minimum dimension above a certain threshold. It is noted that the cavity may be separated from the container interior by a series of such barriers, of which at least one is inseparable from the body of the liquid treatment device. The barrier may be only a mesh or liquid-permeable foil, inseparably and sealingly joined around its edge to the body of the liquid treatment device. It may alternatively be formed by a section of a wall defined by the body, with the body being made in one piece.

In an embodiment, the barrier is a wall section in which at least one of the second windows is provided, and any seams in a transition between the wall section and an adjoining section of the body surrounding the wall section are between parts of the body joined by bonding.

The transition is otherwise seamless, being between parts made in one piece. Liquid cannot pass between an edge of the barrier and the adjoining section of the body. It is forced to flow through the at least one second window in the barrier. The adjoining section of the body surrounding the wall section may be a side wall forming a tube partitioned by the barrier. It may alternatively be the liquid-impermeable wall forming at least the bottom of the container.

In a first variant of this embodiment therefore, the wall section is made in one piece with a wall defining at least the bottom of the container.

In another variant of the same embodiment, the wall section is a wall of a housing of the cavity, the housing being joined to the container section, e.g. to a wall defining at least the bottom of the container, by bonding.

In an embodiment of the liquid treatment device, the liquid treatment section includes a cavity side wall, closed on itself about the cavity, and any seams in a transition between a circumference of the cavity side wall, e.g. at an end thereof proximal to the container section, and the at least one liquid-impermeable wall defining at least the bottom of the container are between parts of the body joined by bonding.

This transition is otherwise seamless, meaning between parts of a single body made in one piece. In this embodiment, a bypass of liquid through the liquid-impermeable wall forming at least the bottom of the container and past the liquid treatment section is prevented.

In an embodiment, the cavity side wall forms the first liquid-permeable window. It may include at least one layer of sheet material, e.g. pleated.

In this embodiment, the liquid treatment part includes or is formed by the cavity side wall. It provides a relatively large surface for liquid filtration. It may in particular form a microbial filter. The sheet material may include at least one of a membrane and a functionalised textile sheet, which may be a non-woven textile sheet. The functionalised textile sheet may include material that is physically or chemically activated, e.g. to provide it with an electrostatic potential or generally to make it adsorbent. The sheet material may be stiff enough to be self-supporting, particularly if made of multiple layers. Alternatively it may be supported by at least one self-supporting frame.

In an embodiment, the at least one liquid treatment part includes at least one of a granular and a fibrous liquid treatment medium.

This medium may be loose or bound. Loose or loosely bound granular or fibrous liquid treatment medium presents a relatively large area of contact with the liquid.

In an embodiment, the at least one liquid treatment part is arranged in the cavity.

The barrier is arranged to retain the liquid treatment medium, which can thus comprise relatively fine particles or fibres, e.g. with a density lower than that of the liquid, when submerged in the liquid. The barrier prevents such fine particles or fibres from escaping. It may also maintain a dense bed in which channels cannot readily form. Thus, granular or fibrous liquid treatment medium can be in the form of loose matter.

In a variant of this embodiment, an interior surface of a side wall of the cavity bounds the cavity.

Liquid in contact with the liquid treatment part, e.g. a liquid treatment medium for treating liquid in a diffusive process, is also able to contact the interior surface of the cavity side wall. There is relatively little unused space in the cavity.

In a variant of this embodiment, a liquid treatment medium arranged in the cavity is arranged to contact the interior surface of the side wall of the cavity.

This ensures that liquid cannot easily pass untreated or undertreated between the liquid treatment medium and the interior surface of the cavity side wall. The liquid treatment medium extends uniformly to the interior surface of the cavity side wall. The liquid treatment medium is not contained in a liquid-permeable bag or sachet. Since the liquid treatment medium is completely enclosed by walls, it cannot and need not be replaced at the end of its useful lifetime. Instead, it is recycled with the body of the liquid treatment device. Therefore, bags or sachets for removing loose liquid treatment medium from the cavity can be dispensed with.

In an embodiment of the liquid treatment device, at least one of the liquid treatment parts includes at least an ion exchange resin.

Such resins have a tendency to swell when contacted by liquid. The inseparable barrier cannot be dislodged by such swelling, so that the ion exchange resin is retained at the required density.

In an embodiment of the liquid treatment device, the barrier is concave, viewed from the cavity.

This provides a space in which gas may collect. The at least one second liquid-permeable windows in the barrier extend to a level below an apex of the concave section of the barrier, to allow liquid to enter the cavity.

In an embodiment, the liquid treatment section has an elongated cross-section.

This allows the cross-section to be relatively large for a given minimum lateral dimension of the liquid treatment device. Liquid can remain in the liquid treatment part for a relatively long time without leading to unacceptably long throughflow times. This embodiment is particularly suitable for gravity-driven liquid treatment systems in which the liquid treatment device is for placement in a jug or pitcher.

In an embodiment of the liquid-treatment device, a side wall of the liquid treatment section and one of the barrier and an end wall at an opposite end of the liquid treatment section to the barrier are integral parts of a beaker-shaped component made in one piece.

The beaker-shaped component is relatively easy to handle. It can in particular be bonded to another part at its mouth after the liquid treatment part or parts have been placed in it. If the beaker-shaped component is made in one piece, manufacturing is simplified.

In a variant of this embodiment, the other of the barrier and the end wall at the opposite end of the liquid treatment section is joined to the beaker-shaped component to form an assembly, and the assembly is joined to the container section.

This embodiment is thus essentially composed of a liquid treatment section similar to a conventional replaceable liquid treatment cartridge, which liquid treatment section is inseparably and sealingly joined to a container section similar to a conventional funnel or tank to form a replaceable unit for a liquid treatment system. It is relatively easy to manufacture.

In an embodiment of the liquid treatment device, a side wall of the container section is provided with a laterally protruding ridge at a mouth of the container on an opposite side of the container section to the liquid treatment section.

This allows the container section and thus the liquid treatment device to be suspended within a further container, e.g. a jug, pitcher, carafe or dispenser tank. The laterally protruding ridge can be placed on a rim of a mouth of such a further container or on a ledge formed on an inside of a side wall of such a container near its mouth.

In an embodiment, the walls of the liquid treatment section enclosing the cavity are liquid-impermeable but for any of the first and second liquid-permeable windows provided in them.

The cavity forms a chamber for holding liquid treatment medium. The liquid-impermeable walls force the liquid to pass through the cavity in a particular direction and to remain in the cavity for a certain time. This effect is useful where at least one liquid treatment medium for the treatment of liquid in a diffusive process is arranged in the cavity.

In an embodiment of the liquid treatment device, the liquid-impermeable walls of the body are self-supporting.

In this embodiment, the container section in particular cannot collapse. This distinguishes this embodiment from liquid treatment devices comprising a bladder with a liquid treatment device sealed in an outlet thereof. The embodiment is relatively easy to mount in a liquid treatment system.

According to another aspect, the liquid treatment system according to the invention includes a container for collecting treated liquid and a liquid treatment device according to the invention, suspendable above a base of the container for collecting treated liquid.

In an embodiment, the liquid treatment device is suspendable within the container for collecting treated liquid.

This allows a lid of the container for collecting treated liquid also to cover the container interior. The liquid treatment device need not have its own lid.

In an embodiment therefore, the liquid treatment system includes a separate lid for covering an interior of the container for holding liquid to be treated, e.g. a lid with a fill opening.

According to another aspect, the method according to the invention of manufacturing a liquid treatment device according to the invention includes forming a body including at least one of the walls and joining the body and the other walls together.

Joining may in particular be by bonding, such that any seams between the walls are liquid-impermeable.

A variant of this embodiment includes manufacturing the liquid treatment section and the container section separately and joining the liquid treatment section to the container section.

With this embodiment, a relatively large production run of container sections may be produced. Different variants of the liquid treatment section, e.g. including different liquid treatment parts, may be produced separately and joined to container sections on demand and relatively shortly before delivery.

### BRIEF DESCRIPTION OF THE DRAWINGS

The invention will be explained in further detail with reference to the accompanying drawings, in which:

FIG. 1 is a side view of a liquid treatment system;

FIG. 2 is a cross-sectional view of part of a first replaceable liquid treatment device for the liquid treatment system of FIG. 1;

FIG. 3 is a cross-sectional view of part of a second replaceable liquid treatment device for the liquid treatment system of FIG. 1;

FIG. 4 is a cross-sectional view of part of a third replaceable liquid treatment device for the liquid treatment system of FIG. 1;

FIG. 5 is a cross-sectional view of part of a fourth replaceable liquid treatment device for the liquid treatment system of FIG. 1;

FIG. 6 is a cross-sectional view of part of a fifth replaceable liquid treatment device for the liquid treatment system of FIG. 1;

FIG. 7 is a cross-sectional view of part of a sixth replaceable liquid treatment device for the liquid treatment system of FIG. 1;

FIG. 8 is a cross-sectional view of part of a seventh replaceable liquid treatment device for the liquid treatment system of FIG. 1; and

FIG. 9 is a cross-sectional view of part of an eighth replaceable liquid treatment device for the liquid treatment system of FIG. 1.

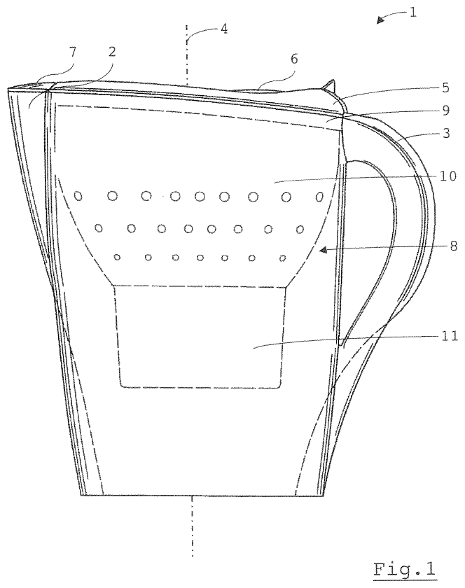

### DETAILED DESCRIPTION OF THE INVENTION

A liquid treatment system for the treatment of aqueous liquids such as mains drinking water includes a jug 1 as an example of a container for collecting treated liquid. The jug 1 is provided with a pouring spout 2 and a handle 3. The jug 1 is open at an end opposite a base. The jug 1 has an elongated cross-sectional shape for cross-sections perpendicular to an upright axis 4 that is oriented substantially vertically when the jug 1 is stood on its base.

The open end of the jug 1 is closed by a lid 5 including a fill opening closed by a pivotable closure element 6. A pivotable spout cover 7 is part of the lid 5 and closes the pouring spout 2 when the jug 1 is stood on its base.

A liquid treatment device in the form of a funnel 8 is suspended within the jug 1. To this end, an exterior ridge 9 at an, in use, upper end of the funnel 8 is supported by a ledge formed on an interior surface of a side wall of the jug 1. The ledge and ridge 9 need not extend all the way around the circumference of the funnel 8. The ledge is at such a level that the funnel 8 is suspended completely within the jug 1. The lid 5 is supported by the jug 1 and covers a mouth of the funnel 8.

It is possible to define an upright axis of the funnel 8, in this example aligned with the jug axis 4 when the funnel 8 is suspended in the jug 1. Seen in axial direction, the funnel 8 comprises two adjacent sections. One section 10 defines a container for holding liquid to be treated. Another section 11 defines a cavity through which liquid is forced to flow and in which at least one liquid treatment medium may be arranged.

The container section 10 includes a side wall separating an interior of the container from the environment. This side wall is closed on itself about the funnel axis. An edge at an in use upper end of the funnel 8 defines a mouth of the funnel 8. The exterior ridge 9 is provided at this end. The side wall slopes inwards towards the liquid treatment section 11 defining the cavity, so that the section 10 defining the container for holding liquid to be treated has no clearly defined bottom wall. In a different embodiment (not shown), there may be such a wall transitioning into the side wall at a clearly defined edge.

The cavity in the liquid treatment section 11 may form a chamber arranged to hold one or more liquid treatment media for treating liquids such as aqueous liquids. An example would be mains drinking water or another aqueous beverage. The liquid treatment media may include liquid treatment media for the treatment of liquid in a diffusive process, e.g. media removing or adding components to the liquid. In particular, the media may include a liquid treatment medium for the treatment of liquid by sorption, which for present purposes includes ion exchange, adsorption and absorption. The media may include activated carbon. They may include an ion exchange resin, e.g. a cation exchange resin. The cation exchange resin may include cation exchange resin in the hydrogen form. In a particular embodiment, a majority of the ion exchange resin is in the hydrogen form. For more effective use of the available volume, the cation exchange resin may be weakly acidic cation exchange resin. The liquid treatment medium will generally be at least partly in granular form.

At least one of the walls of the funnel 8 is provided with at least one liquid-permeable window allowing liquid, but not any granular matter above a certain size, from the cavity in the liquid treatment section 11 to egress from the funnel 8. At least one of the walls of the funnel 8 is provided with at least one liquid-permeable window allowing liquid, but not any granular matter in the cavity above a certain size, to pass between an interior of the container defined by the section 10 and the cavity. Otherwise, a wall section comprised in a liquid-impermeable wall is situated between the cavity and the container interior, so that these are separated from each other by at least that wall section. The wall section is comprised in one of a set of liquid-impermeable walls that are integral parts of a body of the funnel 8. Each of these walls is either inseparably joined to the remainder of the body or an integral part of a body section made in one piece, so that the wall transitions seamlessly into the remainder of the body.

Liquid-impermeable walls of the funnel 8 will generally be made of plastic, e.g. styrene-acrylonitrile (SAN), polyethylene polypropylene, styrene maleic anhydride (SMA) or polystyrene. The latter-mentioned two materials, in particular SMA, provide a lasting relatively glossy finish without extensive use of additives. Where the walls are joined, they are bonded, so that a positive material joint is formed. This means that the material of the walls and that of an optional adhesive or filler material is coalesced. They may be joined by welding, soldering or adhesive bonding. The walls are self-supporting, maintaining a substantially stable shape without any need for external reinforcement.

In a first implementation (FIG. 2) of the funnel 8, the funnel side wall 212 transitions seamlessly into the separating wall section 213, so that they are integral parts of the same body, which is made in one piece. The body may be obtained by injection-moulding, for example. The body also includes a side wall 214 of the liquid-treatment section 211, which surrounds a cavity 215. This cavity side wall 214 is closed on itself about an upright funnel axis 216. The cavity side wall 214 is shaped to provide the cavity 215 with an elongated cross-section (with the cross-sectional plane perpendicular to the funnel axis 216).

The cavity side wall 214 is provided with a flange 217 at an axial end opposite the transition between the cavity side wall 214 and the funnel side wall 212. A bond 218 of the type mentioned above joins an axial end wall 219 to the flange 217 of the cavity side wall 214 to close the cavity 215. The axial end wall 219 is provided with through-going channels forming liquid-permeable outlet windows.

Viewed from the cavity 215, the wall section 213 is concave. It is substantially dome-shaped. Venting apertures 220a,b are provided at the apex of the dome. Slits 221a,b form liquid-permeable inlet windows allowing liquid to pass from a container interior 222 to the cavity 215. These slits 221a,b extend substantially to a base of the dome. A mesh 223 is provided between a liquid treatment medium 224 arranged in the cavity 215 and the wall section 213. The liquid treatment medium 224 is granular, fibrous or a mixture of the two. The interior surface of the cavity side wall 214 bounds the cavity 215, so that the liquid treatment medium 224 is free to contact this interior surface.

To manufacture the funnel in its first implementation, the mesh 223 is joined to the separating wall section 213 along its edge. This assembly is turned upside down to fill the cavity 215 with the liquid treatment medium 224. The axial end wall 219 is then joined to the cavity side wall 214.

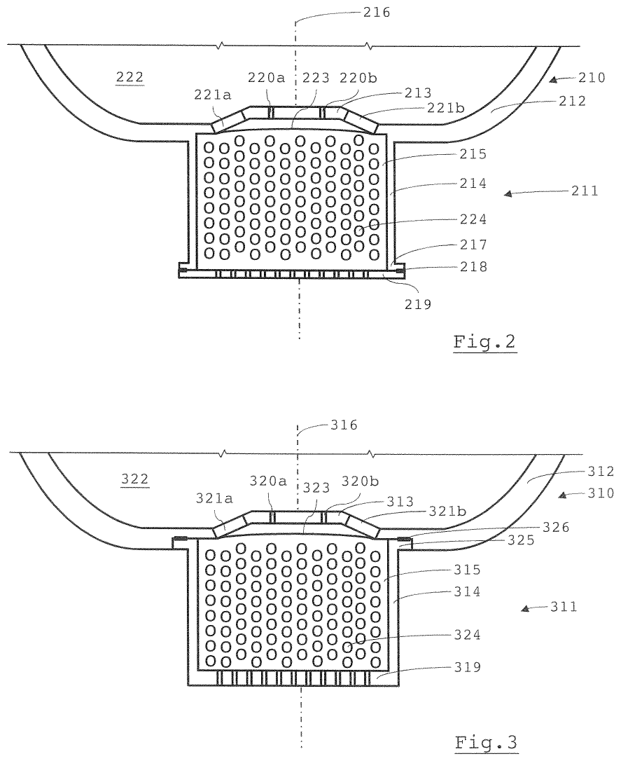

In a second implementation (FIG. 3) of the funnel 8, the funnel side wall 312 also transitions seamlessly into the separating wall section 313, so that they are integral parts of the same body, made in one piece, e.g. by injection-moulding.

The liquid treatment section 311 includes a beaker-shaped component formed by a cavity side wall 314 and an axial end wall 319 of the liquid treatment section 311 and defining a cavity 315. In this case, therefore, the transition between the axial end wall 319 and the cavity side wall 314 is seamless. The beaker-shaped component may be moulded, e.g. injection-moulded. The cavity side wall 314 is closed on itself about an upright funnel axis 316. The cavity side wall 314 is shaped to provide the cavity 315 with an elongated cross-section (with the cross-sectional plane perpendicular to the funnel axis 316).

The cavity side wall 314 is provided with a flange 325 at an axial end proximal the funnel side wall 312. A bond 326 of the type mentioned above joins the funnel side wall 312 to the flange 325 of the cavity side wall 314 to close off the cavity 315.

The axial end wall 319 is provided with through-going channels forming liquid-permeable outlet windows. Viewed from the cavity 315, the separating wall section 313 is concave. It is substantially dome-shaped. Venting apertures 320a,b are provided at the apex of the dome. Slits 321a,b form liquid-permeable inlet windows allowing liquid to pass from a container interior 322 to the cavity 315. A mesh 323 is provided between a liquid treatment medium 324 arranged in the cavity 315 and the wall section 313. The interior surface of the cavity side wall 314 bounds the cavity 315, however. Nothing else separates this interior surface from the liquid treatment medium 324, so that the latter is free to contact this interior surface.

To manufacture the funnel in its second implementation, the beaker-shaped component is filled with the liquid treatment medium 324. The mesh 323 may be joined to the flange 325 first, before this assembly is joined to the funnel side wall 312. Alternatively, it may be clamped between the funnel side wall 312 and the flange 325, before the bond 326 is formed.

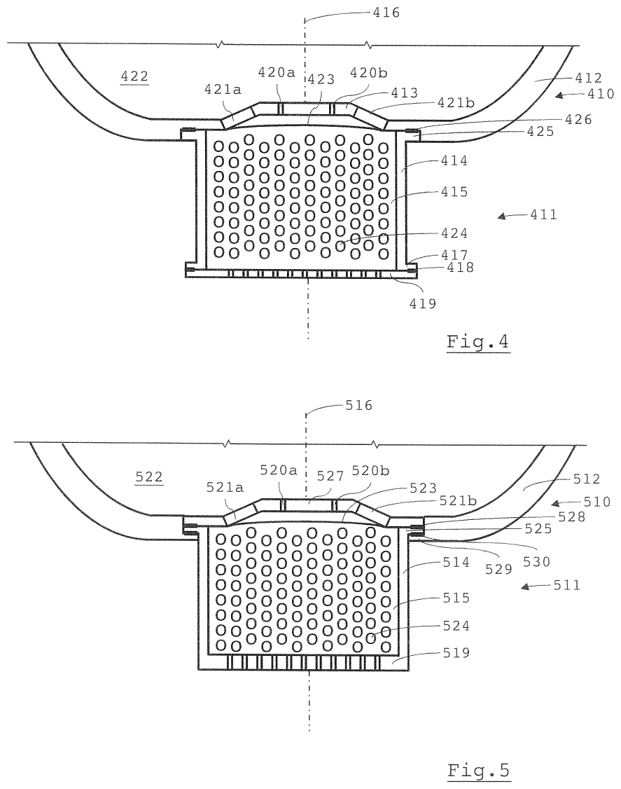

In a third implementation (FIG. 4) of the funnel 8, the funnel side wall 412 also transitions seamlessly into the separating wall section 413 so that they are integral parts of the same body, made in one piece. A side wall 414 of the liquid treatment section 411 defining the cavity 415 is a separate, e.g. moulded, part. The cavity side wall 414 is closed on itself about an upright funnel axis 416. The cavity side wall 414 is shaped to provide the cavity with an elongated cross-section (with the cross-sectional plane perpendicular to the funnel axis 416). The cavity side wall 414 is provided with a first flange 417 at an axial end distal to the funnel side wall 412 and with a second flange 425 at an axial end proximal to the funnel side wall 412. A first bond 426 of the type mentioned above joins the proximal flange 425 to the funnel side wall 412. A second bond 418 of the type mentioned above joins the flange 418 at the distal axial end to an axial end wall 419, so as to close the cavity 415. The axial end wall 419 is provided with through-going channels forming liquid-permeable outlet windows.

Viewed from the cavity 415, the wall section 413 is concave. It is substantially dome-shaped. Venting apertures 420a,b are provided at the apex of the dome. Slits 21a,b form liquid-permeable inlet windows allowing liquid to pass from a container interior 422 to the cavity 415. A mesh 423 is provided between a liquid treatment medium 424 arranged in the cavity 415 and the wall section 413. The interior surface of the cavity side wall 414 bounds the cavity 415 with nothing between it and the liquid treatment medium 424, so that the latter is free to contact this interior surface. The liquid treatment medium 424 is granular, fibrous or a combination thereof.

To manufacture the funnel in its third implementation, the axial end wall 419 may first be joined to the cavity side wall 414. In that case, the remaining steps are the same as those for manufacturing the funnel in its second implementation. Alternatively, it is possible to join the mesh 423 and the cavity side wall 414 together first. In that case, the remaining steps are the same as those for manufacturing the funnel in its first implementation.

In a fourth implementation (FIG. 5) of the funnel 8, a cartridge with a conventional configuration is manufactured first and joined to the funnel side wall 512 so as to occupy an aperture in a bottom thereof.

A beaker-shaped component comprises a side wall 514 of the liquid treatment section 511 defining the cavity 515, which side wall 514 is closed on itself about an upright funnel axis 516. The cavity side wall 514 is shaped to provide the cavity 515 with an elongated cross-section (with the cross-sectional plane perpendicular to the funnel axis 516). The beaker-shaped component further comprises an axial end wall 519 of the liquid treatment section 511, so that the transition between the cavity side wall 514 and the axial end wall 519 is seamless. The axial end wall 519 is provided with through-going channels forming liquid-permeable outlet windows.

The cavity side wall 514 is provided with a flange 525 at an axial end distal to the axial end at which the axial end wall 519 is provided and proximal to the funnel side wall 512.

A cap-shaped component 527 includes the wall section separating a container interior 522 from the liquid treatment section 511. The cap-shaped component 527 is provided with a circumferential rim by which it is inseparably joined to the flange 525 so as to form an upper bond 528 of the type mentioned above. This closes off the cavity 515. Viewed from the cavity 515, the cap-shaped component 527 is concave. It is substantially dome-shaped. Venting apertures 520a,b are provided at the apex of the dome. Slits 521a,b form liquid-permeable inlet windows allowing liquid to pass from a container interior 522 to the cavity 515. A mesh 523 is provided between a liquid treatment medium 524 arranged in the cavity 15 and the cap-shaped component 527. An interior surface of the cavity side wall 514 bounds the cavity 515 with nothing between it and the liquid treatment medium 524, so that the liquid treatment medium 524 is free to contact this interior surface.

The flange 525 is also joined to a rim 529 surrounding the aperture defined in the funnel side wall 512 so as to form a lower bond 530 of the type mentioned above. The lower flange bond 530 prevents any bypass of liquid, ensuring that all the liquid in the container interior 522 passes through the cavity 515.

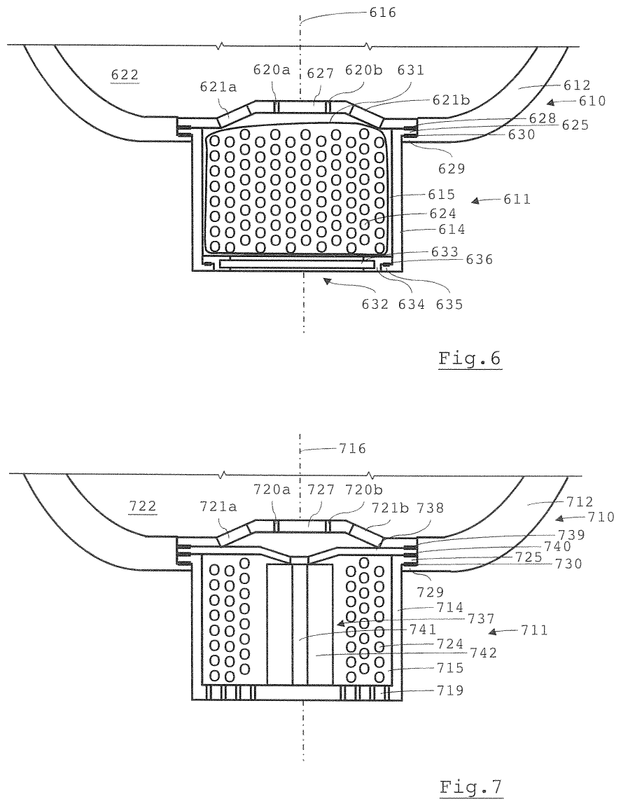

A fifth implementation (FIG. 6) of the funnel 8 is similar to the fourth implementation. However, in this implementation, the mesh 523 is omitted. Instead, a liquid treatment medium 624 is enveloped in a liquid-permeable bag 631, e.g. made out of liquid-permeable woven or non-woven fabric or a liquid-permeable foil. The liquid treatment medium 624 is granular, fibrous or a mixture of the two. An interior surface of a cavity side wall 614 still bounds the cavity 615 and liquid contacting the liquid treatment medium 624 is also free to contact this interior surface. However, direct contact between the liquid treatment medium 624 and the interior surface of the cavity side wall 614 is substantially prevented.

An axial end wall is essentially formed by a filter element 632 of the type described more fully in WO 2013/139821 A1 This filter element 632 includes a porous, liquid-permeable body 633. It further includes a rim 634 covering at least a peripheral face of the porous body 633 so as to frame first and second major surface areas thereof. The filter element 632 is joined to a rim 635 of the cavity side wall 614 by a bond 636 of the type mentioned above. Thus, the porous body 633 is comprised in the liquid-permeable window allowing liquid from the cavity 615 to egress.

It is noted that the filter element 632 need not be combined with liquid treatment medium 624 in a liquid-permeable bag 631. Each of these features can be adopted without the other.

A sixth implementation (FIG. 7) of the funnel 8 is similar to the fourth and fifth implementation.

A beaker-shaped component comprises a side wall 714 of the liquid treatment section 711 defining a cavity 715, which cavity side wall 714 is closed on itself about an upright funnel axis 716. The cavity side wall 714 is shaped to provide the cavity 715 with an elongated cross-section (with the cross-sectional plane perpendicular to the funnel axis 716). The beaker-shaped component further comprises an axial end wall 719 of the liquid treatment section 711, so that the transition between the cavity side wall 714 and the axial end wall 719 is seamless. The axial end wall 719 is provided with through-going channels forming liquid-permeable outlet windows. However, these through-going channels are only provided in a peripheral section of the axial end wall 719.

The cavity side wall 714 is provided with a flange 725 at an axial end distal to the axial end at which the axial end wall 719 is provided and proximal to the funnel side wall 712.

A cap-shaped component 727 includes the wall section separating an interior 722 of the container for holding liquid to be treated from the liquid treatment section 711. The cap-shaped component 727 is provided with a circumferential rim. A liquid treatment module 737 includes a liquid-impermeable separating wall 738 with a liquid-permeable window in the form of a central aperture. The separating wall 738 is positioned between the cavity 715 and the cap-shaped component 727. The separating wall 738 is also provided with a flange, which is positioned between and in contact with the cap-shaped component 727 and the flange 725 of the cavity side wall 714. Bonds 739,740,730 of the type discussed above join these walls together in a sealed and inseparable manner. The liquid treatment module 737 includes a central channel 741 in sealed liquid communication with the liquid-permeable window through the separating wall 738 at one axial end. The central channel 741 is closed at an opposite axial end. Flow through the liquid treatment module 737 in use is in a radial direction between the central channel 741 and a remainder of the cavity 715.

This radial flow is through a module liquid treatment medium 742, which may be arranged to effect a purely mechanical filtration and/or may include any of the liquid treatment media discussed above, e.g. arranged in a thermally bonded liquid-permeable porous block.

In an alternative embodiment (not shown in detail), the separating wall 738 is in sealed liquid communication with a membrane filtration module, e.g. a hollow fibre membrane module. In such an embodiment, the membrane comprises the liquid treatment medium.

As illustrated, a further liquid treatment medium 724 is arranged in the cavity 15 around the liquid treatment module 737. This liquid treatment medium 724 may be granular in nature, fibrous or a mixture of the two. It may comprise any of the liquid treatment medium types discussed above, e.g. including an ion exchange resin.

The interior surface of the cavity side wall 714 bounds the cavity 715 with nothing between it and the liquid treatment medium 724, so that the liquid treatment medium 724 is free to contact this interior surface.

Viewed from the direction of the cavity 715, the cap-shaped component 727 is concave. It is substantially dome-shaped. Venting apertures 720a,b are provided at the apex of the dome. Slits 721a,b form liquid-permeable inlet windows allowing liquid to pass from the container interior 722 into a space between the separating wall 738 and the cap-shaped component 727, and from there into the central channel 741 of the liquid treatment module 737.

To manufacture the funnel in its sixth implementation, the liquid treatment module 737 and surrounding liquid treatment medium 724 are first placed in the beaker-shaped component. The cap-shaped component 727 is then placed on top. This assembly may either be placed into an aperture in the bottom of the section 10 defining the container for holding liquid to be treated, so that the bonds 739,740,730 may then be formed substantially simultaneously. This would work well if welding is used. Alternatively, upper and lower separating wall bonds 739,740 may be formed before the assembly is placed in the aperture in the bottom of the section 710 defining the container for holding liquid to be treated.

In all implementations, the whole funnel 8 is replaced at the end of its useful lifetime and the inseparable, sealed connection between the two sections 10,11 ensures that there are no bypass flows of untreated liquid into the jug 1.

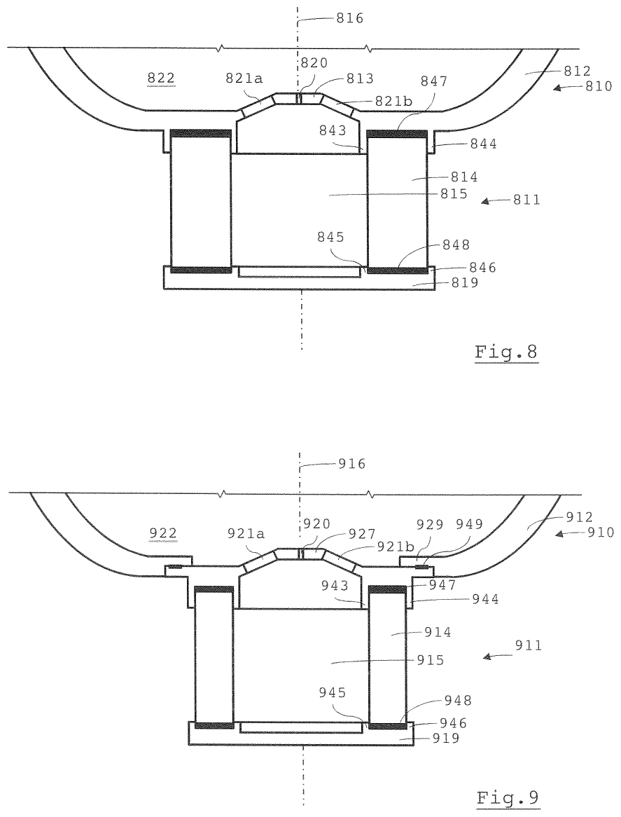

A seventh implementation (FIG. 8) of the funnel 8 also includes a container section 810 and a liquid treatment section 811. The liquid-impermeable funnel side wall 812 transitions seamlessly into a separating wall section 813, so that they are integral parts of the same body, which is made in one piece. The body may be obtained by injection-moulding, for example. In this way, it is impossible for liquid to flow out of a container interior 822 without passing into the liquid treatment section 811.

The body also includes inner and outer annular depending wall sections 843,844. These are likewise made in one piece with the wall forming at least the bottom of the container section 810.

The liquid treatment section 811 includes a cavity 815, which in this embodiment is empty. It may contain a granular or fibrous liquid treatment medium of the types mentioned above, or a mixture thereof, in an alternative embodiment.

In this embodiment, a liquid-permeable cavity side wall 814 is provided. This cavity side wall 814 is closed on itself about an upright funnel axis 816. The cavity side wall 814 is shaped to provide the cavity 815 with an essentially circular cross-section (with the cross-sectional plane perpendicular to the funnel axis 816). The cross-section may be elongated in an alternative embodiment.

The liquid-permeable cavity side wall 814 includes at least one layer of sheet material. At least one such layer of sheet material may be in the form of a membrane or a woven or non-woven textile arranged to filter microbes. The textile fibres may be functionalised to provide them with chemical or electrophysical properties that enable the sheet material made of these fibres to filter out microbes. For example, the textile material may include silver or a silver salt or compound. It may include electroactive or charge-modified fibres. Such fibres are effective to retain microorganisms through electroadsorption. Material including such fibres may include sites having an electrokinetic potential in the range of 20-75 mV, e.g. 40-70 mV, for example. The fibres of the textile material may include fibres made of or provided with a coating including a metal oxide, e.g. aluminium oxide, aluminium hydroxide or zirconium oxide. A particular example is boehmite (γ-AlO(OH)). The fibres may have a diameter in the range of 2-1000 nm, e.g. in the range of 2-100 nm. They may have a ratio of length to diameter of between 1 and 5, for example.

Other fibres of one or more layers of sheet material of the cavity side wall 814 may be cellulose fibres, glass fibres, viscose fibres, polyester fibres, polyethylene fibres, polypropylene fibres, cotton fibres or a mixture thereof, optionally with a binder.

The cavity side wall 814 may include a layer of sheet material comprising activated carbon fibres. Such sheet material is obtainable by heat treatment of a non-woven textile material made of organic fibres to carbonise them, followed by an activation step. Alternatively, a layer of sheet material may include powdered activated carbon, which need not be bound, e.g. powdered activated carbon having a mean particle size (d₅₀) in the range of 2-10 μm.

Specific examples of suitable sheet material are provided in WO 03/000407 A1, for example. Compared with a semi-permeable membrane, variants with a functionalised woven or non-woven textile sheet material have a lower resistance to flow whilst still being capable of filtering out microbes.

Although not shown, a liquid-permeable support tube may be arranged radially inwards of the sheet material. The sheet material may alternatively be arranged on a self-supporting frame. A screen (not shown) arranged radially outwards of the sheet material may protect it in one embodiment.

Where the sheet material includes a semi-permeable membrane, it may be made of cellulose acetate, polyethersulfone, polyimide, polytetrafluoroethylene, or polycarbonate, for example. The membrane may have porous voids with a mean pore size of between 0.05 and 5 μm, for example, e.g. below 2 μm.

A liquid-impermeable axial end wall 819 is a separate component, shaped to have an inner and outer annular ridge 845,846 directed towards the container section 810.

An upper bond 847 sealingly joins the cavity side wall 814 to the container section 810 at one axial end. A lower bond 848 sealingly joins the cavity side wall 814 to the axial end wall 819. In this way, it is impossible for liquid to leave the liquid treatment section 811 without being treated on its way through the cavity side wall 814. The bonds 847,848 may be made with a potting compound such as polyurethane or with a hot-melt adhesive, for example.

Viewed from the cavity 815, the separating wall section 813 is concave. It is substantially dome-shaped. A venting aperture 820 is provided at the apex of the dome. Slits 821a,b form liquid-permeable inlet windows allowing liquid to pass from a container interior 822 to the cavity 815. These slits 821a,b extend substantially to a base of the dome.

An eighth implementation (FIG. 9) of the funnel 8 is a variant of the seventh implementation, also including a container section 910 and a liquid treatment section 911. In this variant, the liquid treatment section 911 is first manufactured separately from the container section 910, whereupon the two sections are assembled such as to become inseparable.

The liquid treatment section 911 includes an assembly of a liquid-permeable cavity side wall 914 and a liquid-impermeable axial end wall 919. The latter is shaped to have an inner and outer annular ridge 945,946 directed towards the container section 910. The cavity side wall 914 is of the same type as the cavity side wall 814 described above in relation to the seventh implementation. It is similarly joined to the axial end wall 919 by a bond 948. The cavity side wall 914 and the axial end wall 919 for a beaker-shaped component.

The cavity side wall 914 is sealingly joined to a cap-shaped component 927 at its opposite axial end by a bond 947. To this end, the cap-shaped component includes integral inner and outer annular depending wall sections 943,944. The cap-shaped component 927 thus closes off a cavity 915, which in this embodiment is empty. It may contain a granular or fibrous liquid treatment medium of the types mentioned above, or a mixture thereof, in an alternative embodiment.

The cavity side wall 914 is closed on itself about an upright funnel axis 916. The cavity side wall 914 is shaped to provide the cavity 915 with an essentially circular cross-section (with the cross-sectional plane perpendicular to the funnel axis 916). The cross-section may be elongated in an alternative embodiment.

The cap-shaped component 927 is self-supporting and made of liquid-impermeable material. Viewed from the cavity 915, the cap-shaped component 927 is concave. It is substantially dome-shaped. A venting aperture 920 is provided at the apex of the dome. Slits 921a,b form liquid-permeable inlet windows allowing liquid to pass from a container interior 922 to the cavity 915. These slits 921a,b extend substantially to a base of the dome.

The cap-shaped component 927 is formed with a flange by which the liquid-treatment section 911 is joined to the container section 910. Specifically, a bond 949 (adhesive or welded joint) is provided between the flange and a rim 929 surrounding an aperture in a section of the funnel side wall 912 forming the bottom of the container section 910.

Since any seams in transitions between the cavity side wall 14 and the funnel side wall 912 are between parts joined by bonding, untreated liquid in the container interior 922 cannot bypass the liquid treatment part in the liquid treatment section 911, as is the case for each of the embodiments described above. Moreover, contaminants are unable to enter the cavity 915, so that the liquid treatment part has a longer useful life. Once the end of this useful life is reached, the entire funnel 8 is replaced.

The invention is not limited to the embodiments described above, which may be varied within the scope of the accompanying claims. For example, the liquid treatment device may be for placement in a beverage machine, e.g. a coffee maker. Such a system need not include a container for collecting the treated liquid, which may pass straight to the section of the machine in which the beverage is prepared. The machine may include a suction pump for drawing the liquid through the section of the liquid treatment device defining the cavity, in which at least one liquid treatment medium may be arranged.

### LIST OF REFERENCE NUMERALS

1—jug
2—pouring spout
3—handle
4—jug axis
5—lid
6—closure element
7—spout cover
8—funnel
9—ridge
10, 210, 310, 410, 510, 610, 710, 810, 910—container section
11, 211, 311, 411, 511, 611, 711, 811, 911—liquid treatment section
12, 212, 312, 412, 512, 612, 712, 812, 912—funnel side wall
213, 313, 413, 813—wall section
214, 314, 414, 514, 614, 714, 814, 914—cavity side wall
215, 315, 415, 515, 615, 715, 815, 915—cavity
216, 316, 416, 516, 616, 716, 816, 916—funnel axis
217, 417—flange
218, 418—bond
219, 319, 419, 519, 719, 819, 919—axial end wall
220a,b, 320a,b, 420a,b, 520a,b, 620a,b, 720a,b, 820, 920—venting aperture
221a,b, 321a,b, 421a,b, 521a,b, 621a,b, 721a,b, 821a,b, 921a,b—slit
222, 322, 422, 522, 622, 722, 822, 922—container interior
223, 323, 423, 523—mesh
224, 324, 424, 524, 624, 724—liquid treatment medium
325, 425, 525, 625, 725—flange proximal to container section
326, 426—proximal flange bond
527, 627, 727, 927—cap-shaped component
528, 628—upper flange bond
529, 629, 929—rim
530, 630, 730—lower flange bond
631—bag
632—filter element
633—porous body
634—rim
635—cavity side wall rim
636—rim bond
737—liquid treatment module
738—separating wall
739—upper separating wall bond
740—lower separating wall bond
741—central channel
742—module liquid treatment medium
843, 943—inner annular depending wall section
844, 944—outer annular depending wall section
845, 945—inner annular ridge
846, 946—outer annular ridge
847, 947—upper bond
848, 948—lower bond
949—bond

What is claimed is:

1. A liquid treatment device including a body, the body including:
a container section defining a container for holding liquid to be treated and
a liquid treatment section defining a cavity and including at least one liquid treatment part, wherein the body includes
at least one liquid-impermeable wall defining at least a bottom of the container and
at least one wall enclosing the cavity,
wherein these walls of the body are inseparable, any seams in transitions between these walls being between parts of the body joined by bonding, and
wherein the liquid treatment device is provided with at least one first liquid-permeable window allowing liquid to egress from the device and at least one second liquid-permeable window allowing liquid to flow from an interior of the container to the cavity,
wherein the liquid treatment device includes a barrier between the cavity and the container interior, the barrier including at least one of the second windows,
wherein the barrier is inseparable from the body.

2. The liquid treatment device according to claim 1, wherein the barrier is a wall section in which at least one of the second windows is provided, and wherein any seams in a transition between the wall section and an adjoining section of the body surrounding the wall section are between parts of the body joined by bonding.

3. The liquid treatment device according to claim 2, wherein the wall section is made in one piece with a wall defining at least the bottom of the container.

4. The liquid treatment device according to claim 2, wherein the wall section is a wall of a housing of the cavity, the housing being joined to the container section to a wall defining at least the bottom of the container, by bonding.

5. The liquid treatment device according to claim 1, wherein the liquid treatment section includes a cavity side wall closed on itself about the cavity, and wherein any seams in a transition between a circumference of the cavity side wall at an end thereof proximal to the container section, and the at least one liquid-impermeable wall defining at least the bottom of the container are between parts of the body joined by bonding.

6. The liquid treatment device according to claim 5, wherein the cavity side wall forms the first liquid-permeable window, wherein the cavity side wall includes at least one layer of sheet material, e.g. pleated.

7. The liquid treatment device according to claim 1, wherein the at least one liquid treatment part includes at least one of a granular and a fibrous liquid treatment medium.

8. The liquid treatment device according to claim 1, wherein the at least one liquid treatment part is arranged in the cavity.

9. The liquid treatment device according to claim 8, wherein an interior surface of a side wall of the cavity bounds the cavity.

10. The liquid treatment device according to claim 9, wherein a liquid treatment medium arranged in the cavity is arranged to contact the interior surface of the cavity side wall.

11. The liquid treatment device according to claim 1, wherein the liquid treatment section has an elongated cross-section.

12. The liquid treatment device according to claim 1, wherein a side wall of the liquid treatment section and one of the barrier and an end wall at an opposite end of the liquid treatment section to the barrier are parts of a beaker-shaped component, integral parts of a beaker-shaped component made in one piece.

13. A liquid treatment system, including a container for collecting treated liquid and the liquid treatment device according to claim 1, suspendable above a base of the container for collecting treated liquid.

14. A method of manufacturing the liquid treatment device according to claim 1, including the steps of: forming the body including at least one of the walls and joining the body and the other walls together.

15. The method according to claim 14, including manufacturing the liquid treatment section and the container section separately and joining the liquid treatment section to the container section.

16. The liquid treatment device according to claim 2, wherein the liquid treatment section includes a cavity side wall, closed on itself about the cavity, and wherein any seams in a transition between a circumference of the cavity side wall at an end thereof proximal to the container section, and the at least one liquid-impermeable wall defining at least the bottom of the container are between parts of the body joined by bonding, and wherein the cavity side wall forms the first liquid-permeable window, wherein the cavity side wall includes at least one layer of sheet material, e.g. pleated.

17. The liquid treatment device according to claim 16, wherein the at least one liquid treatment part includes at least one of a granular and a fibrous liquid treatment medium, and wherein the at least one liquid treatment part is arranged in the cavity.

18. The liquid treatment device according to claim 17, wherein an interior surface of a side wall of the cavity bounds the cavity, and wherein a liquid treatment medium arranged in the cavity is arranged to contact the interior surface of the cavity side wall.

19. The liquid treatment device according to claim 18, wherein the liquid treatment section has an elongated cross-section, and wherein a side wall of the liquid treatment section and one of the barrier and an end wall at an opposite end of the liquid treatment section to the barrier are parts of a beaker-shaped component, integral parts of a beaker-shaped component made in one piece.

20. A liquid treatment system, including a container for collecting treated liquid and the liquid treatment device according to claim 19, suspendable above a base of the container for collecting treated liquid.
